(19) United States
(12) Patent Application Publication
(10) Pub. No.: US 2019/0094789 A1
(43) Pub. Date: Mar. 28, 2019

(54) TRANSPORT DEVICE INCLUDING TONER REMOVING MEMBER AND IMAGE FORMING APPARATUS INCLUDING THE SAME

(71) Applicant: FUJI XEROX CO., LTD., Tokyo (JP)

(72) Inventors: Tadashi SUTO, Kanagawa (JP); Koichi SATO, Kanagawa (JP); Yoshiyuki TAKASHIMA, Kanagawa (JP)

(73) Assignee: FUJI XEROX CO., LTD., Tokyo (JP)

(21) Appl. No.: 15/946,232

(22) Filed: Apr. 5, 2018

(30) Foreign Application Priority Data
Sep. 27, 2017 (JP) 2017-185835

(51) Int. Cl. G03G 21/00

(52) U.S. Cl. CPC G03G 21/105; G03G 2221/0005; G03G 21/12

(57) ABSTRACT

A transport device includes a transport member and a moving member. The transport member includes a shaft and a blade helically extending on an outer peripheral surface of the shaft. The transport member transports a granular material with a rotation of the shaft. The moving member extends from an outer side of the transport member in a radial direction to the shaft. The moving member includes a distal end portion moving in an axial direction of the shaft in a gap defined by the blade.

### CROSS-REFERENCE TO RELATED APPLICATIONS

This application is based on and claims priority under 35 USC 119 from Japanese Patent Application No. 2017-185835 filed Sep. 27, 2017.

### BACKGROUND

### Technical Field

The present invention relates to a transport device and an image forming apparatus.

### SUMMARY

According to an aspect of the invention, a transport device includes a transport member and a moving member. The transport member includes a shaft and a blade helically extending on an outer peripheral surface of the shaft. The transport member transports a granular material with a rotation of the shaft. The moving member extends from an outer side of the transport member in a radial direction to the shaft. The moving member includes a distal end portion moving in an axial direction of the shaft in a gap defined by the blade.

### BRIEF DESCRIPTION OF THE DRAWINGS

Exemplary embodiments of the present invention will be described in detail based on the following figures, wherein:

FIG. 1 is a schematic diagram of a structure of an image forming apparatus according to an exemplary embodiment;

FIG. 2 is a schematic diagram of a structure of an image forming unit according to the present exemplary embodiment;

FIG. 3 is a schematic diagram of a structure of a transport device according to the present exemplary embodiment;

FIG. 4 is a perspective view of a structure of a removing member according to the present exemplary embodiment;

FIG. 5 is a schematic diagram of a structure of a removing member according to the present exemplary embodiment when viewed in an axial direction of a transport member;

FIG. 6 is a side view of a structure of the removing member according to the present exemplary embodiment;

FIG. 7 is a side view of an operation of the removing member according to the present exemplary embodiment; and

FIG. 8 is a side view of a structure of a removing member according to a modified example.

### DETAILED DESCRIPTION

Exemplary embodiments according to the present invention are described below with reference to the drawings.

### Image Forming Apparatus 10

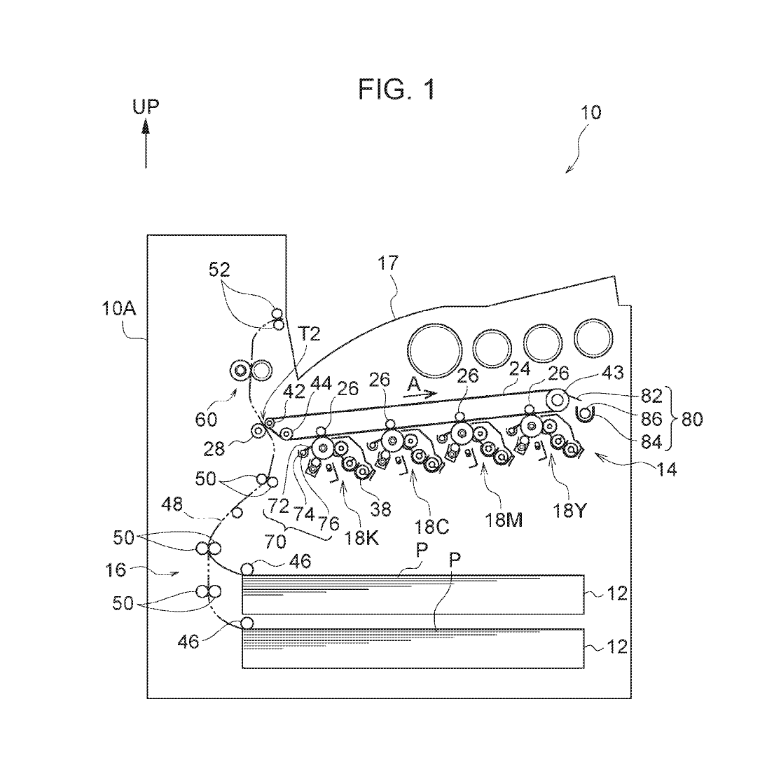

First, the structure of an image forming apparatus 10 is described. FIG. 1 is a schematic diagram of a structure of the image forming apparatus 10. Arrow UP appropriately illustrated in the drawings including FIG. 1 represents vertically upward.

As illustrated in FIG. 1, the image forming apparatus 10 includes an apparatus body 10A, which houses components. The apparatus body 10A houses multiple container units 12, which contain recording media P, such as paper sheets, an image forming portion 14, which forms toner images on the recording media P, and a transport unit 16, which transports the recording media P from each container unit 12 to the image forming portion 14. A discharging unit 17 is disposed at an upper portion of the apparatus body 10A. The discharging unit 17 receives the recording media P discharged thereto after the recording media P have images formed thereon by the image forming portion 14.

The image forming portion 14 includes image forming units 18Y, 18M, 18C, and 18K (hereinafter referred to as 18Y to 18K), which are forming units that form toner images of yellow (Y), magenta (M), cyan (C), and black (K).

The image forming portion 14 also includes an intermediate transfer belt 24 (an example of an intermediate transfer body), to which toner images formed by the image forming units 18Y to 18K are transferred, and a second transfer roller 28, which transfers the toner images transferred to the intermediate transfer belt 24 from the intermediate transfer belt 24 to the recording medium P.

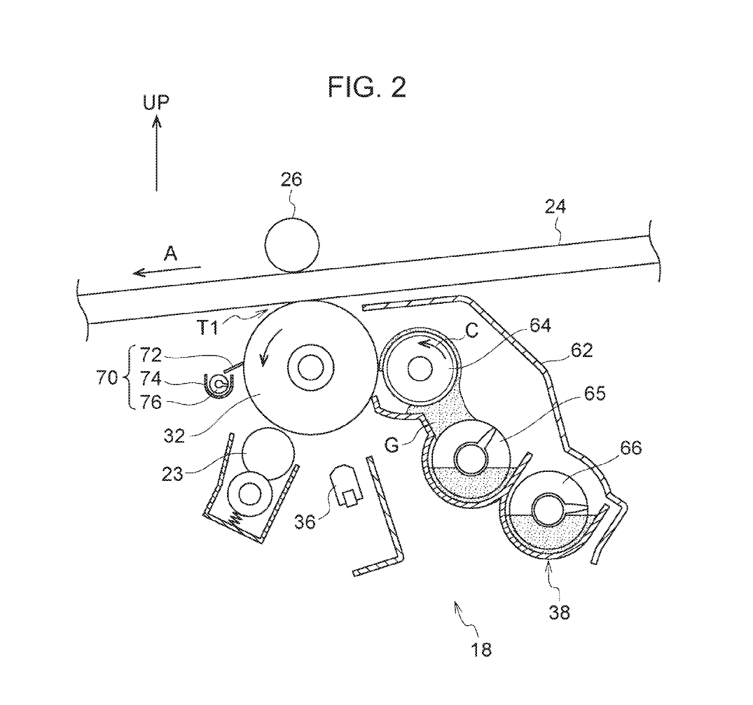

As illustrated in FIG. 2, each of the image forming units 18Y to 18K includes a photoconductor 32, which is an example of a carrier that carries a toner image. The image forming units 18Y to 18K have the same structure except for the colors of toner they use. Thus, the image forming units 18Y to 18K are collectively illustrated as an image forming unit 18 in FIG. 2.

The photoconductor 32 rotates in one direction (for example, in a counterclockwise direction in FIG. 2). A charging roller 23, an exposure device 36, a developing device 38, a first transfer roller 26, and a removal device 70 are disposed around the photoconductor 32 in order from the upstream side in the rotation direction of the photoconductor 32. The charging roller 23 serves as a charging device that charges the photoconductor 32. The exposure device 36 exposes the photoconductor 32 charged by the charging roller 23 to light to form an electrostatic latent image on the photoconductor 32. The developing device 38 develops the electrostatic latent image formed on the photoconductor 32 by the exposure device 36 into a toner image. The first transfer roller 26 transfers the toner image formed on the photoconductor 32 by the developing device 38 to the intermediate transfer belt 24. The removal device 70 removes toner from the photoconductor 32.

As illustrated in FIG. 2, the developing device 38 includes a housing 62, which houses a developer G containing toner and a carrier, a development roller 64, which is disposed in the housing 62 to feed the developer G to the electrostatic latent image on the photoconductor 32, and augers 65 and 66, serving as transporters that transport the developer G fed to the development roller 64 while agitating the developer G. In the present exemplary embodiment, the developing device 38 has the housing 62 filled with the developer G while allowing part of the developer G in the housing 62 to be discharged therefrom.

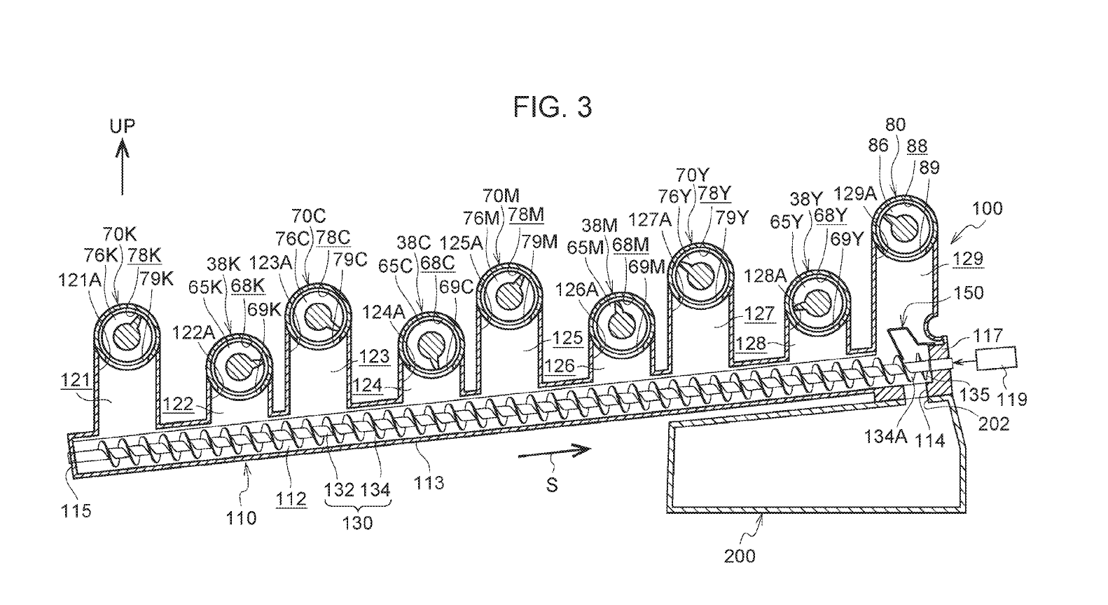

Specifically, the developing device 38 includes a transport path 68 (see FIG. 3), which extends from the housing 62 to an end portion of the auger 65 in the axial direction. The end portion of the auger 65 in the axial direction is disposed in the transport path 68. The auger 65 transports part of the developer G in the housing 62 along the transport path 68. The developer G transported along the transport path 68 is discharged through an outlet 69 (see FIG. 3) formed in the transport path 68. In FIG. 3, the reference signs of the developing devices 38, the augers 65, the transport paths 68, and the outlets 69 are appropriately appended with Y, M, C, and K in accordance with the color of toner used.

As illustrated in FIG. 2, the removal device 70 includes a remover 72, which is an example of a first removing unit that removes toner from the photoconductor 32, a receiving member 74, which receives toner removed by the remover 72, and an auger 76, which serves as a transporter for transporting the toner received by the receiving member 74.

The remover 72 specifically has a function of removing toner remaining on the photoconductor 32 by coming into contact with the photoconductor 32. More specifically, the remover 72 is a blade that comes into contact with the photoconductor 32 to remove the toner remaining on the photoconductor 32 after toner is transferred to the intermediate transfer belt 24. Here, another member such as a brush may be used as the first removing unit.

The removal device 70 also includes a transport path 78 (see FIG. 3), which extends from the receiving member 74 to an end of the auger 76 in the axial direction. The end of the auger 76 in the axial direction is disposed in the transport path 78. The auger 76 transports the toner in the receiving member 74 along the transport path 78. The toner transported along the transport path 78 is discharged through an outlet 79 (see FIG. 3) formed in the transport path 78. In FIG. 3, the reference sings of the removal devices 70, the augers 76, the transport paths 78, and the outlets 79 are appropriately appended with Y, M, C, and K in accordance with the color of toner used.

The intermediate transfer belt 24 illustrated in FIG. 1 is annular. Specifically, the intermediate transfer belt 24 is seamless and endless. The intermediate transfer belt 24 is wound around multiple rollers 42, 43, and 44.

When, for example, any one or more of the multiple rollers 42, 43, and 44 rotate, the intermediate transfer belt 24 rotates in one direction (for example, A direction) while being in contact with the first transfer rollers 26 and the photoconductors 32 (see FIG. 2). The roller 42 also functions as an opposing roller (back-up roller) facing the second transfer roller 28.

As illustrated in FIG. 2, the first transfer roller 26 faces the photoconductor 32 with the intermediate transfer belt 24 interposed therebetween. A portion between the first transfer roller 26 and the photoconductor 32 serves as a first transfer portion T1, at which the toner image formed on the photoconductor 32 is transferred to the intermediate transfer belt 24.

As illustrated in FIG. 1, the second transfer roller 28 faces the roller 42 with the intermediate transfer belt 24 interposed therebetween. A portion between the second transfer roller 28 and the roller 42 serves as a second transfer portion T2, at which the toner images transferred to the intermediate transfer belt 24 are transferred to a recording medium P.

Thus, the intermediate transfer belt 24 has a function of receiving toner images from the multiple photoconductors 32 at the respective first transfer portions T1, and a function of transferring the toner images to a recording medium P at the second transfer portion T2.

As illustrated in FIG. 1, the image forming portion 14 includes a removal device 80, which removes toner from the intermediate transfer belt 24. The removal device 80 includes a remover 82, which is an example of a second removing unit that removes toner from the intermediate transfer belt 24, a receiving member 84, which receives toner removed by the remover 82, and an auger 86, which serves as a transporter for transporting the toner received by the receiving member 84.

Specifically, the remover 82 has a function of removing toner remaining on the intermediate transfer belt 24 by coming into contact with the intermediate transfer belt 24. More specifically, the remover 82 is a blade that comes into contact with the intermediate transfer belt 24 to remove the toner remaining on the intermediate transfer belt 24 after toner is transferred to the recording medium P. Here, another member such as a brush may be used as a second removing unit.

The removal device 80 also includes a transport path 88 (see FIG. 3), which extends from the receiving member 84 to an end portion of the auger 86 in the axial direction. The end portion of the auger 86 in the axial direction is disposed in the transport path 88. The auger 86 transports the toner in the receiving member 84 along the transport path 88. The toner transported along the transport path 88 is discharged through an outlet 89 formed in the transport path 88.

The present exemplary embodiment has a mode of transferring untransferred images, which are not transferred from the intermediate transfer belt 24 to a recording medium P, from the photoconductors 32 of the image forming units 18Y to 18K.

Examples of untransferred images include a density detection image (patch) for detecting the toner density of a toner image on the intermediate transfer belt 24, a color-shift detection image (patch) for detecting misalignment between colors of the toner images on the intermediate transfer belt 24, and an image (band) for consuming a degraded developer (toner). The image (band) is transferred, for example, to a portion of the intermediate transfer belt 24 extending from one end to the other end in the width direction. The untransferred image is not transferred to the recording medium P and the toner of the untransferred image is removed by the remover 82.

As illustrated in FIG. 1, the transport unit 16 in the image forming apparatus 10 includes pick-up rollers 46, each of which picks up a recording medium P contained in the corresponding container unit 12, a transport path 48, along which a recording medium P picked up by each pick-up roller 46 is transported, and multiple transport rollers 50, which are arranged along the transport path 48 to transport the recording medium P picked up by the pick-up roller 46 to the first transfer portions T1.

A fixing device 60 is disposed above (downstream in the transport direction from) the second transfer portion T2. The fixing device 60 fixes the toner image transferred to the recording medium P by the second transfer roller 28 onto the recording medium P. Discharge rollers 52 are disposed above (downstream in the transport direction from) the fixing device 60. The discharge rollers 52 discharge, to the discharging unit 17, the recording medium P to which the toner image has been fixed.

### Transport Device 100 and Container 200

As illustrated in FIG. 3, the image forming apparatus 10 includes a transport device 100, which transports toner, and a container 200, which serves as a container unit containing the toner transported by the transport device 100. The toner serves as an example of a granular material.

Specifically, the transport device 100 is a device for transporting waste toner. More specifically, the transport device 100 is a device for transporting the developers (toner and carrier) discharged from the developing devices 38, toner removed by the removers 72 of the removal devices 70, and toner removed by the remover 82 of the removal device 80. Although the transport device 100 transports toner and a carrier, the toner and the carrier are simply referred to as toner, below.

As illustrated in FIG. 3, the transport device 100 includes a housing 110, a transport member 130, and a removing member 150.

The housing 110 constitutes a transport device body. The housing 110 forms a transport path 112, which extends substantially horizontally, multiple inlet passages 121, 122, 123, 124, 125, 126, 127, 128, and 129 (121 to 129, below), which extend vertically, and an outlet 114.

The transport path 112 is a transport path along which the toner is transported substantially horizontally. In other words, the transport path 112 is a transport path along which the toner is transported transversely. Specifically, the transport path 112 is a transport path along which the toner is transported from the left to the right in FIG. 3.

The transport direction on the transport path 112 is denoted with arrow S in FIG. 3. Hereinbelow, “upstream in the transport direction” and “downstream in the transport direction” may be simply referred to as “upstream” and “downstream”. In addition, “the transport direction on the transport path 112” may be simply referred to as “the transport direction”.

The transport path 112 extends obliquely upward from the upstream side to the downstream side. In other words, the transport path 112 has the downstream side on the higher level than the upstream side.

The inlet passages 121 to 129 extend upward from the transport path 112. The inlet passages 121 to 129 are arranged in this order from the upstream side to the downstream side in the transport direction of the transport path 112.

The inlet passage 121 is continuous with the transport path 78K of the removal device 70K. The inlet passage 121 has, at an upper end portion, an inlet 121A, into which the toner discharged from the outlet 79K of the transport path 78K flows. The toner that has flowed into the inlet 121A falls freely through the inlet passage 121 and flows into the transport path 112. Specifically, the inlet passage 121 serves as a fall passage through which the toner that has flowed into the inlet 121A falls freely.

The inlet passage 122 is continuous with the transport path 68K of the developing device 38K. The inlet passage 122 has, at an upper end portion, an inlet 122A, into which the developer discharged from the outlet 69K of the transport path 68K flows. The developer that has flowed into the inlet 122A falls freely through the inlet passage 122 and flows into the transport path 112. Specifically, the inlet passage 122 serves as a fall passage through which the developer that has flowed into the inlet 122A falls freely.

The inlet passage 123 is continuous with the transport path 78C of the removal device 70C. The inlet passage 123 has, at an upper end portion, an inlet 123A, into which the toner discharged from the outlet 79C of the transport path 78C flows. The toner that has flowed into the inlet 123A falls freely through the inlet passage 123 and flows into the transport path 112. Specifically, the inlet passage 123 serves as a fall passage through which the toner that has flowed into the inlet 123A falls freely.

The inlet passage 124 is continuous with the transport path 68C of the developing device 38C. The inlet passage 124 has, at an upper end portion, an inlet 124A, into which the developer discharged from the outlet 69C of the transport path 68C flows. The developer that has flowed into the inlet 124A falls freely through the inlet passage 124 and flows into the transport path 112. Specifically, the inlet passage 124 serves as a fall passage through which the developer that has flowed into the inlet 124A falls freely.

The inlet passage 125 is continuous with the transport path 78M of the removal device 70M. The inlet passage 125 has, at an upper end portion, an inlet 125A, into which the toner discharged from the outlet 79M of the transport path 78M flows. The toner that has flowed into the inlet 125A falls freely through the inlet passage 125 and flows into the transport path 112. Specifically, the inlet passage 125 serves as a fall passage through which the toner that has flowed into the inlet 125A falls freely.

The inlet passage 126 is continuous with the transport path 68M of the developing device 38M. The inlet passage 126 has, at an upper end portion, an inlet 126A, into which the developer discharged from the outlet 69M of the transport path 68M flows. The developer that has flowed into the inlet 126A falls freely through the inlet passage 126 and flows into the transport path 112. Specifically, the inlet passage 126 serves as a fall passage through which the developer that has flowed into the inlet 126A falls freely.

The inlet passage 127 is continuous with the transport path 78Y of the removal device 70Y. The inlet passage 127 has, at an upper end portion, an inlet 127A, into which the toner discharged from the outlet 79Y of the transport path 78Y flows. The toner that has flowed into the inlet 127A falls freely through the inlet passage 127 and flows into the transport path 112. Specifically, the inlet passage 127 serves as a fall passage through which the toner that has flowed into the inlet 127A falls freely.

The inlet passage 128 is continuous with the transport path 68Y of the developing device 38Y. The inlet passage 128 has, at an upper end portion, an inlet 128A, into which the developer discharged from the outlet 69Y of the transport path 68Y flows. The developer that has flowed into the inlet 128A falls freely through the inlet passage 128 and flows into the transport path 112. Specifically, the inlet passage 128 serves as a fall passage through which the developer that has flowed into the inlet 128A falls freely.

The inlet passage 129 is continuous with the transport path 88 of the removal device 80. The inlet passage 129 has, at an upper end portion, an inlet 129A, into which the toner discharged from the outlet 89 of the transport path 88 flows. The toner that has flowed into the inlet 129A falls freely through the inlet passage 129 and flows into the transport path 112. Specifically, the inlet passage 129 serves as a fall passage through which the toner that has flowed into the inlet 129A falls freely.

The outlet 114 illustrated in FIG. 3 is an opening through which toner flows out from the transport path 112. The outlet 114 is formed in a bottom plate 113 of the housing 110 at a downstream end portion of the transport path 112. Thus, the toner transported to the downstream side of the transport path 112 falls freely through the outlet 114.

The container 200 illustrated in FIG. 3 is a container that receives the toner that has fallen freely through the outlet 114. The container 200 has an opening 202 at an upper portion. The opening 202 is connected to the outlet 114. The toner that has fallen freely through the outlet 114 is contained in the container 200 through the opening 202.

The transport member 130 is disposed in the transport path 112. The transport member 130 is a transport member that transports toner that has flowed into the transport path 112. Specifically, the transport member 130 is a transport member that transports toner along the transport path 112 from the left to the right in FIG. 3.

The transport member 130 includes a shaft 132 and a blade 134, helically extending on the outer peripheral surface of the shaft 132.

The shaft 132 extends along the transport path 112. Specifically, the shaft 132 extends substantially horizontally. In other words, the shaft 132 extends transversely. The shaft 132 extends obliquely upward from one end (upstream end) to the other end (downstream end) in the axial direction. In other words, the shaft 132 has the downstream side in the transport direction disposed on the higher level than the upstream side in the transport direction.

Hereinbelow, “the axial direction of the shaft 132” may be simply referred to as “the axial direction”.

The shaft 132 is a solid or hollow cylinder. In other words, the shaft 132 has a cylindrical outer surface (cylindrical surface).

The shaft 132 has one and the other ends in the axial direction rotatably supported by side walls 115 and 117 of the housing 110 at an upstream end and a downstream end of the transport path 112. The shaft 132 is driven by a driving unit 119 to rotate.

The blade 134 extends helically on the outer peripheral surface of the shaft 132 from one end to the other end of the shaft 132 in the axial direction. The blade 134 has a transport surface 134A facing to one side (right in FIG. 3) of the axial direction of the shaft 132. The blade 134 transports toner by pushing the toner with the transport surface 134A while rotating in one direction of the shaft 132. Specifically, the transport surface 134A is an example of a surface facing downstream in the transport direction.

As described above, the transport member 130 transports toner along the transport path 112. The transport path 112 is an example of a transport area over which the transport member 130 transports toner.

A blade 135 is disposed on the outer peripheral surface of the shaft 132 at a downstream end portion. The blade 135 is wound in the opposite direction in which the blade 134 is wound.

### Removing Member 150

The removing member 150 illustrated in FIG. 3 to FIG. 6 is an example of a moving member that has an end portion moving in the axial direction of the shaft 132 in the gap defined by the blade 134. Specifically, the removing member 150 is a member that removes toner adhering to the shaft 132 in the gap defined by the blade 134. More specifically, the removing member 150 is a member that scrapes off toner adhering to the shaft 132 in the gap defined by the blade 134.

The removing member 150 is disposed at a downstream end portion of the transport member 130 and moves in the gap defined by the blade 134 disposed at a downstream end portion of the shaft 132 of the transport member 130. The removing member 150 is disposed on the outer side of the shaft 132 of the transport member 130 in the radial direction. Specifically, the removing member 150 is disposed above the shaft 132 of the transport member 130.

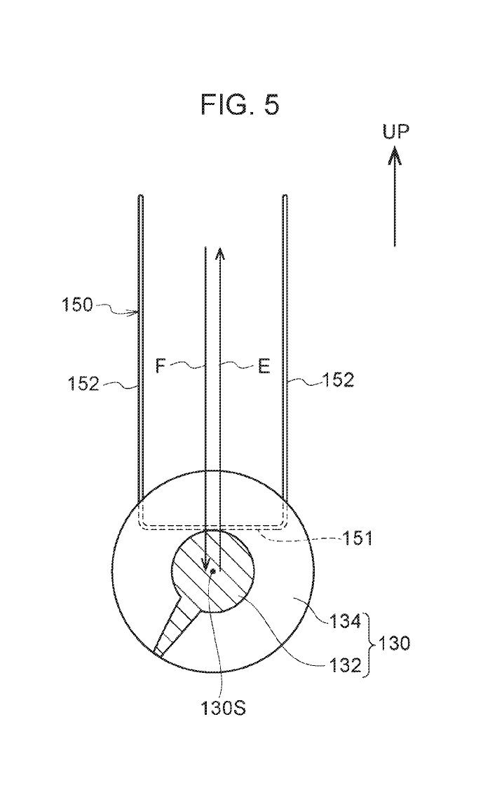

The outer side in the radial direction refers to, as indicated with arrow E in FIG. 5, the side relatively spaced further from an axial center 130S of the transport member 130 (shaft 132) in the radial direction of the transport member 130 (shaft 132) or the direction parallel to the radial direction. The inner side in the radial direction refers to the side opposite to the outer side in the radial direction. Specifically, the inner side in the radial direction refers to, as indicated with arrow F in FIG. 5, the side relatively located closer toward the axial center 130S of the transport member 130 (shaft 132) in the radial direction of the transport member 130 (shaft 132) or the direction parallel to the radial direction.

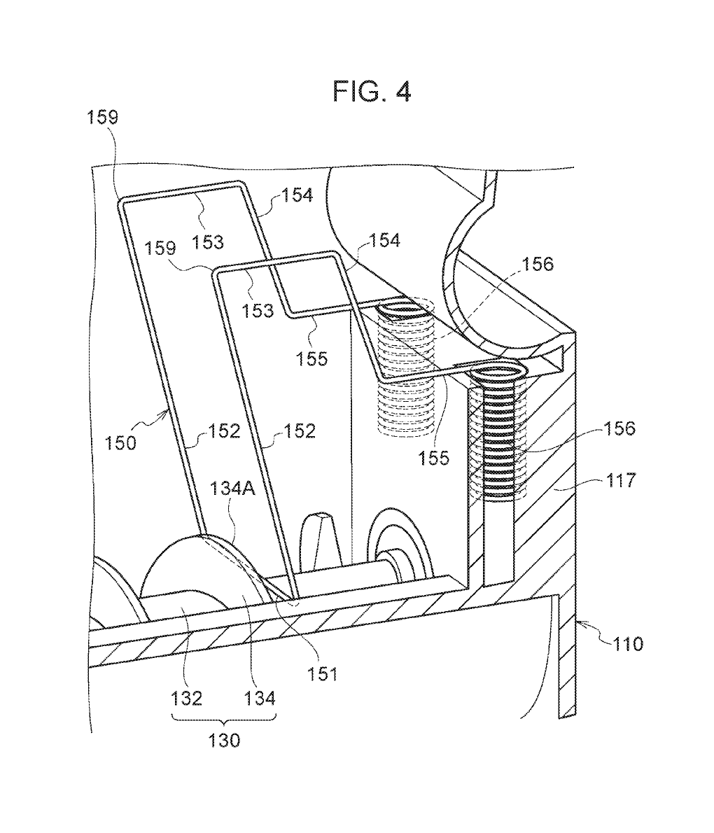

As illustrated in FIG. 4, the removing member 150 is, for example, a thin wire member. Specifically, the removing member 150 is a wire spring. More specifically, the removing member 150 is formed from, for example, a metal wire. The removing member 150 is formed from, for example, a wire having a diameter of smaller than or equal to 1.2 mm.

The removing member 150 includes a first portion 151, a pair of second portions 152, a pair of third portions 153, a pair of fourth portions 154, a pair of fifth portions 155, and a pair of attachment portions 156.

As illustrated in FIG. 5, the first portion 151 is a portion extending in the direction tangential to the shaft 132. Specifically, the first portion 151 is disposed along a tangent to a cross-sectional top portion of the shaft 132. The first portion 151 is in contact with the outer peripheral surface of the shaft 132. As described below, when the first portion 151 moves downstream in the transport direction in the axial direction of the shaft 132 and outward in the radial direction, the first portion 151 is spaced further from the outer peripheral surface of the shaft 132.

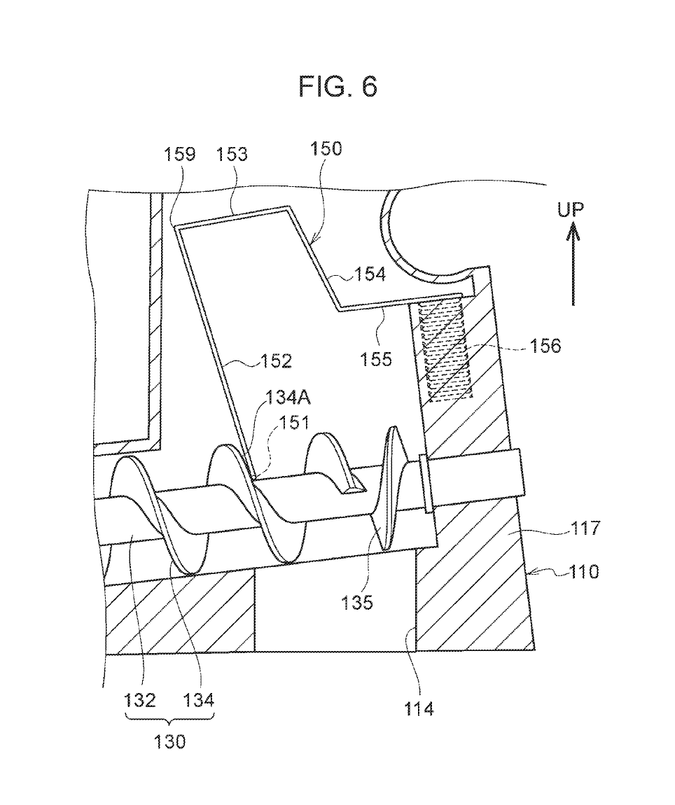

The first portion 151 forms a distal end portion of the removing member 150. As illustrated in FIG. 6, the first portion 151 is pressed against the transport surface 134A of the blade 134 with the elastic force of the removing member 150.

As illustrated in FIG. 5, the second portions 152 extend outward in the radial direction of the transport member 130 from one and the other ends of the first portion 151. In other words, the second portions 152 extend toward the shaft 132 from the outside in the radial direction of the transport member 130.

In the removing member 150, the first portion 151 is movable in the transport direction (axial direction of the shaft 132) about connection portions 159 between the second portions 152 and the third portions 153. In the removing member 150, the connection portions 159 are elastically deformed. Specifically, the connection portions 159 are substantial elastically deformable portions.

The connection portions 159 are examples of positioning portions disposed on the outside of the transport member 130 in the radial direction. As illustrated in FIG. 6, the connection portions 159 are disposed upstream from the first portion 151 in the transport direction.

The connection portions 159 may be also referred to as outer end portions of the second portions 152 in the radial direction. In other words, the connection portions 159 may be also referred to as upper end portions of the second portions 152. The connection portions 159 may be also referred to as middle portions between the first portion 151 (an example of a distal end portion) and the attachment portions 156 (examples of proximal end portions) of the removing member 150.

The second portions 152 have a length longer than the dimension of a gap defined by the blade 134 in the axial direction. Specifically, the length from the first portion 151 to each connection portion 159 is longer than a dimension of the gap defined by the blade 134 in the axial direction. In other words, the length from the first portion 151 to each connection portion 159 is longer than the length of one pitch of the blade 134.

Each third portion 153 extends downstream in the transport direction from an upper end portion of the second portion 152. In other words, each third portion 153 extends in the axial direction of the shaft 132.

Each fourth portion 154 is a portion extending inward in the radial direction from the downstream end portion of the corresponding third portion 153. In other words, each fourth portion 154 extends downward from the downstream end portion of the corresponding third portion 153.

Each fifth portion 155 extends downstream in the transport direction from the lower end portion of the corresponding fourth portion 154. In other words, each fifth portion 155 extends in the axial direction of the shaft 132. Each fifth portion 155 is disposed closer to the transport member 130 than is the corresponding third portion 153. In other words, each fifth portion 155 is disposed lower than the corresponding third portion 153.

Each attachment portion 156 is connected to a downstream end portion of the corresponding fifth portion 155. Each attachment portion 156 is coiled around an axis extending vertically. Each attachment portion 156 forms a proximal end portion of the removing member 150.

Each attachment portion 156 is attached to the side wall 117 at the downstream end of the transport path 112. In other words, each attachment portion 156 is attached to the housing 110 outside the inlet passage 129. In other words, each attachment portion 156 is attached to the housing 110 outside the transport path 112.

Each attachment portion 156 is attached at a portion closer to the shaft 132 than is the corresponding connection portion 159. Specifically, each attachment portion 156 is attached at a portion lower than the corresponding connection portion 159. In other words, each connection portion 159 is disposed on the outer side in the radial direction than the portion at which the corresponding attachment portion 156 is attached.

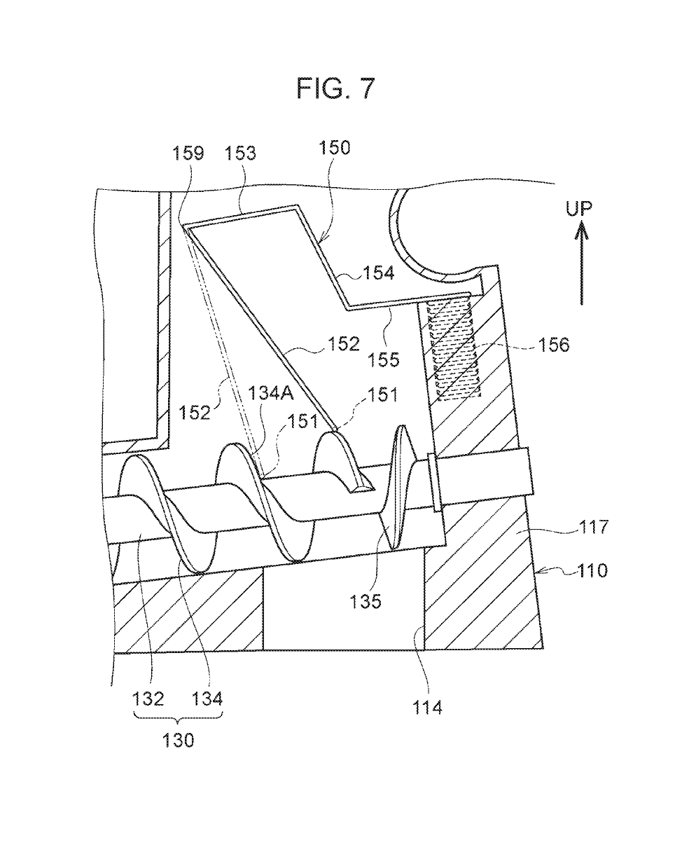

In the present exemplary embodiment, as described above, the first portion 151 of the removing member 150 is pressed against the transport surface 134A with the elastic force of the removing member 150 to be movable downstream in the transport direction and outward in the radial direction in the axial direction about the connection portions 159. As illustrated in FIG. 7, the first portion 151 of the removing member 150 moves in the axial direction of the shaft 132 in the gap defined by the blade 134.

Specifically, when the transport member 130 rotates and the first portion 151 of the removing member 150 is pressed by the transport surface 134A of the blade 134 against the pressing force of the first portion 151 exerted on the transport surface 134A, the first portion 151 moves downstream in the transport direction and outward in the radial direction in the axial direction about the connection portions 159. In other words, the first portion 151 rotates about the connection portions 159 downstream in the transport direction. When the first portion 151 reaches the outer side portion of the blade 134 in the radial direction, the first portion 151 moves upstream in the transport direction in the axial direction in the gap defined by the blade 134 with the pressing force of the removing member 150. Specifically, when the first portion 151 reaches the outer side portion of the blade 134 in the radial direction, the first portion 151 returns upstream in the transport direction with the pressing force (or its elastic force) of the removing member 150. When the first portion 151 returns upstream in the transport direction, the first portion 151 returns to the state of being pressed against the transport surface 134A.

FIG. 7 illustrates, with solid lines, the state where the first portion 151 reaches the outer side of the blade 134 in the radial direction after moving in the axial direction about the connection portions 159 downstream in the transport direction and outward in the radial direction. FIG. 7 also illustrates, with two-dot chain lines, the state before the first portion 151 moves.

In the present exemplary embodiment, as illustrated in FIG. 7, the outlet 114 is disposed below the removing member 150. Specifically, the outlet 114 is disposed below a portion of the removing member 150 excluding the attachment portions 156. Specifically, the outlet 114 is disposed below the first portion 151, the second portions 152, the third portions 153, the fourth portions 154, and the fifth portions 155 of the removing member 150. Here, “the structure disposed below” includes the case where the outlet 114 is disposed below the above portions while the first portion 151 is being moved. More specifically, the outlet 114 is disposed below an area over which the first portion 151 moves.

As illustrated in FIG. 3, the above-described outlet 89 and the inlet 129A are disposed above the removing member 150. Specifically, the outlet 89 and the inlet 129A are disposed above a portion of the removing member 150 excluding the attachment portions 156. Specifically, the outlet 89 and the inlet 129A are disposed above the first portion 151, the second portions 152, the third portions 153, the fourth portions 154, and the fifth portions 155 of the removing member 150. Here, “the structure disposed above” includes the case where the outlet 89 and the inlet 129A are disposed above the above-described portions while the first portion 151 is being moved. More specifically, the outlet 89 and the inlet 129A are disposed above an area over which the first portion 151 moves.

At least part of the removing member 150 is disposed in the inlet passage 129. Specifically, a portion of the removing member 150 excluding the attachment portions 156 is disposed in the inlet passage 129 and at the junction of the inlet passage 129 and the transport path 112. Specifically, the first portion 151, the second portions 152, the third portions 153, the fourth portions 154, and the fifth portions 155 of the removing member 150 are disposed in the inlet passage 129. Here, “the structure disposed in the inlet passage 129” includes the case where these portions are disposed in the inlet passage 129 while the first portion 151 is being moved.

### Operations of Present Exemplary Embodiment

In each of the image forming units 18Y to 18K (see FIG. 1) of the image forming apparatus 10, the auger 65 transports part of the developer G (carrier and toner) in the housing 62 (see FIG. 2) of the developing device 38 along the transport path 68 (see FIG. 3). The developer G transported along the transport path 68 is discharged through the corresponding outlet 69.

The developer discharged from each outlet 69 flows into one of the inlet passages 122, 124, 126, and 128 (122 to 128, below) through the inlet 122A, 124A, 126A, or 128A (see FIG. 3). The developer that has flowed into the inlet passages 122 to 128 falls freely through the inlet passages 122 to 128 and flows into the transport path 112.

In each of the image forming units 18Y to 18K (see FIG. 1), the remover 72 of the removal device 70 removes toner remaining on the photoconductor 32 after having a toner image transferred to the intermediate transfer belt 24. The removed toner is transported by the auger 76 along the transport path 78. The toner transported along the transport path 78 is discharged through the outlet 79.

The toner discharged from each outlet 79 flows into one of the inlet passages 121, 123, 125, and 127 (121 to 127, below) through the inlet 121A, 123A, 125A, or 127A (see FIG. 3). The toner that has flowed into the inlet passages 121 to 127 falls freely through the inlet passages 121 to 127 and flows into the transport path 112.

The remover 82 of the removal device 80 (see FIG. 1) removes toner remaining on the intermediate transfer belt 24 after having a toner image transferred to the recording medium P. The removed toner is transported by the auger 86 along the transport path 88 (see FIG. 3). The toner transported along the transport path 88 is discharged through the outlet 89.

The toner discharged from the outlet 89 flows into the inlet passage 129 through the inlet 129A (see FIG. 3). The toner that has flowed into the inlet passage 129 falls freely through the inlet passage 129 and flows into the transport path 112.

The toner that has flowed into the transport path 112 is transported in the direction of arrow S, as illustrated in FIG. 3, with the rotation of the shaft 132 of the transport member 130 while being pressed by the transport surface 134A of the blade 134.

The toner that has been transported to a downstream end portion of the transport path 112 falls freely through the outlet 114. The toner that has fallen freely through the outlet 114 is contained in the container 200 through the opening 202.

In the present exemplary embodiment, as illustrated in FIG. 7, the first portion 151 of the removing member 150 moves in the axial direction of the shaft 132 in the gap defined by the blade 134.

Specifically, when the transport member 130 rotates, the first portion 151 of the removing member 150 is pressed by the transport surface 134A of the blade 134 against the pressing force of the first portion 151 exerted on the transport surface 134A to move in the axial direction about the connection portions 159 downstream in the transport direction and outward in the radial direction. Thus, the removing member 150 removes the toner adhering to the shaft 132 in the gap defined by the blade 134 and scrapes off the toner adhering to the shaft 132 in the gap defined by the blade 134.

When the first portion 151 reaches the outer side of the blade 134 in the radial direction, the first portion 151 moves upstream in the transport direction in the axial direction in the gap defined by the blade 134 by the pressing force of the removing member 150. Specifically, when the first portion 151 reaches the outer side of the blade 134 in the radial direction, the first portion 151 returns upstream in the transport direction with the pressing force of the removing member 150. In this manner, the first portion 151 removes toner adhering to the shaft 132 in the gap defined by the blade 134 and scrapes off the toner adhering to the shaft 132 in the gap defined by the blade 134. When the first portion 151 returns upstream in the transport direction, the first portion 151 returns to the state of being pressed against the transport surface 134A.

Here, in a structure (first comparative example) where the removing member 150 moves only in the radial direction of the shaft 132, the removing member 150 does not move in the axial direction in the gap defined by the blade 134. Here, unless the removing member 150 has a dimension in the axial direction equivalent to the dimension of the gap defined by the blade 134, the removing member 150 is incapable of removing the toner adhering to the shaft 132 in the gap defined by the blade 134.

In the present exemplary embodiment, in contrast, the first portion 151 moves in the axial direction of the shaft 132 in the gap defined by the blade 134, as described above. Compared to the first comparative example, the dimension of the removing member 150 in the axial direction of the shaft 132 is smaller while having a function of dropping toner adhering to the shaft 132 in the gap defined by the blade 134. The removing member 150, having a smaller dimension in the axial direction of the shaft 132, prevents toner from clogging in the transport path 112.

In the present exemplary embodiment, as described above, when the transport member 130 rotates, the first portion 151 moves in the axial direction of the shaft 132 in the gap defined by the blade 134.

A structure (second comparative example) that moves the first portion 151 of the removing member 150 using a driving force other than the driving force of the rotatable transport member 130 has to have a driving source other than the driving unit 119, which drives the transport member 130 to rotate. The present exemplary embodiment, in contrast, does not have to have a driving source designed only to move the removing member 150, and includes fewer driving sources than the second comparative example.

In the present exemplary embodiment, as illustrated in FIG. 6, the connection portions 159 are disposed upstream from the first portion 151 in the transport direction. Here, in a structure (third comparative example) where the connection portions 159 are disposed downstream from the first portion 151 in the transport direction, when the first portion 151 is to move downstream in the transport direction, the first portion 151 moves downward (inward in the radial direction) until the first portion 151 arrives at the same position as the connection portions 159 in the transport direction, and then moves upward (outward in the radial direction). The first portion 151 is thus more likely to become caught on the outer peripheral surface of the shaft 132 while moving downstream in the transport direction or while returning upstream in the transport direction.

In the present exemplary embodiment, in contrast, the connection portions 159 are disposed upstream from the first portion 151 in the transport direction. Thus, the first portion 151 moves upward (outward in the radial direction) while the first portion 151 is moving downstream in the transport direction. Thus, compared to the third comparative example, the first portion 151 is prevented from becoming caught on the outer peripheral surface of the shaft 132 while moving in the axial direction of the shaft 132.

In the present exemplary embodiment, the distance from the first portion 151 to the connection portions 159 is longer than the length of one pitch of the blade 134. Compared to the structure where the distance from the first portion 151 to the connection portions 159 is shorter than the length of one pitch of the blade 134, the distance from the first portion 151 to the connection portions 159, serving as a rotational center, is longer. Thus, the first portion 151 exerts a smaller pressing force on the transport surface 134A. This structure prevents noise that would be otherwise caused when the first portion 151 is returned upstream in the transport direction and pressed against the transport surface 134A with the pressing force of the removing member 150, or prevents a rise of the torque of the transport member 130.

In the present exemplary embodiment, the connection portions 159 are disposed on the outer side, in the radial direction, of the positions at which the attachment portions 156 are attached. Thus, compared to the structure where the connection portions 159 are located at the position in the radial direction of the transport member 130 the same as the position at which the attachment portions 156 are attached, the distance from the first portion 151 to the connection portions 159, serving as the rotation center, is longer. Thus, the first portion 151 exerts a smaller pressing force on the transport surface 134A. This structure prevents noise that would be otherwise caused when the first portion 151 is returned upstream in the transport direction and pressed against the transport surface 134A with the pressing force of the removing member 150, or prevents a rise of the torque of the transport member 130.

In the present exemplary embodiment, the first portion 151 is in contact with the outer peripheral surface of the shaft 132. Compared to the structure where the first portion 151 is constantly in noncontact with the outer peripheral surface of the shaft 132, the first portion 151 more efficiently drops toner adhering to the outer peripheral surface of the shaft 132 in the gap defined by the blade 134.

In the present exemplary embodiment, the outlet 114 is disposed below the removing member 150. Compared to the structure in which the outlet 114 is disposed at a portion displaced from the portion below the removing member 150, this structure prevents toner from clogging in the outlet 114.

In the present exemplary embodiment, the inlet 129A is disposed above the removing member 150. Compared to the structure where the inlet 129A is disposed at a portion displaced from the portion above the removing member 150, this structure prevents toner from accumulating on the transport member 130.

In the present exemplary embodiment, the removing member 150 is disposed in the inlet passage 129. Compared to the structure where the removing member 150 is disposed outside the inlet passage 129, this structure prevents toner from accumulating on the transport member 130.

Here, toner removed from the intermediate transfer belt 24 flows into the inlet passage 129 through the inlet 129A. The multiple photoconductors 32 transfer toner images to the intermediate transfer belt 24. Thus, the amount of toner remaining on the intermediate transfer belt 24 may be larger than the amount of toner remaining on the photoconductors 32. Particularly, when an untransferred image is transferred to the intermediate transfer belt 24, the amount of toner remaining on the intermediate transfer belt 24 is larger. Thus, the amount of toner removed by the remover 82 of the removal device 80 may be large. In the present exemplary embodiment, the inlet 129A is disposed above the removing member 150 and the removing member 150 is disposed in the inlet passage 129. This structure prevents toner from accumulating on the transport member 130 even when the amount of toner removed by the remover 82 of the removal device 80 is large.

In the present exemplary embodiment, the attachment portions 156 of the removing member 150 are attached to the housing 110 outside the inlet passage 129. Compared to the structure where the attachment portions 156 are attached to the housing 110 inside the inlet passage 129, this structure prevents toner from accumulating in the inlet passage 129.

In the present exemplary embodiment, the attachment portions 156 are attached to the housing 110 outside the transport path 112. Compared to the structure where the attachment portions 156 are attached to the housing 110 inside the transport path 112, this structure prevents toner from stagnating in the transport path 112.

In the present exemplary embodiment, the removing member 150 is formed from a thin wire, as illustrated in FIG. 4. Compared to the structure where the removing member 150 is formed from a plate, this structure prevents toner from stagnating in the transport path 112.

In the present exemplary embodiment, the removing member 150 includes the first portion 151, extending in the direction tangential to the shaft 132, and the second portions 152, which extend outward in the radial direction of the transport member 130 from one and the other ends of the first portion 151. Compared to the structure where the first portion 151, serving as the distal end portion of the removing member 150, extends only in the radial direction of the shaft 132, this structure more efficiently drops toner adhering to the outer peripheral surface of the shaft 132 in the gap defined by the blade 134.

### Modified Examples

In the present exemplary embodiment, when the transport member 130 rotates, the first portion 151 moves in the axial direction of the shaft 132 in the gap defined by the blade 134. However, this is not the only possible structure. For example, the first portion 151 of the removing member 150 may be moved by a driving source designed only to move the removing member 150. Specifically, the first portion 151 of the removing member 150 may be moved by a driving force other than the driving force for driving the transport member 130 to rotate.

In the present exemplary embodiment, the connection portions 159 are disposed upstream of the first portion 151 in the transport direction, as illustrated in FIG. 6. However, this is not the only possible structure. For example, the connection portions 159 may be disposed at the position in the transport direction the same as the position of the first portion 151. Alternatively, for example, the connection portions 159 may be disposed downstream of the first portion 151 in the transport direction.

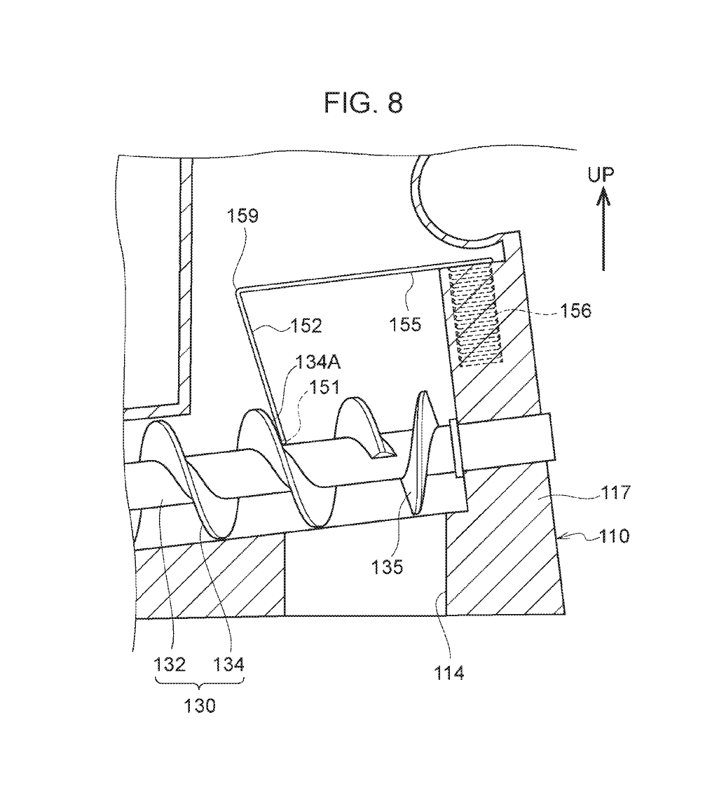

In the present exemplary embodiment, the connection portions 159 are disposed outward, in the radial direction, of the position at which the attachment portions 156 are attached. However, this is not the only possible structure. For example, the connection portions 159 may be disposed at the position, in the radial direction of the transport member 130, the same as the position at which the attachment portions 156 are attached. In an example of this structure, as illustrated in FIG. 8, the fifth portions 155 extend from the attachment portions 156 upstream in the transport direction and are connected to the second portions 152. In this case, the connection portions between the second portions 152 and the fifth portions 155 function as the above-described connection portions 159.

In the present exemplary embodiment, the first portion 151 comes into contact with the outer peripheral surface of the shaft 132. However, this is not the only possible structure. For example, the first portion 151 may be kept in noncontact with the outer peripheral surface of the shaft 132. The first portion 151 suffices if it moves in the axial direction of the shaft 132 in the gap defined by the blade 134.

In the present exemplary embodiment, the outlet 114 is disposed below the removing member 150. However, this is not the only possible structure. For example, the outlet 114 may be disposed at a portion displaced from the portion below the removing member 150.

In the present exemplary embodiment, the inlet 129A is disposed above the removing member 150. However, this is not the only possible structure. For example, the inlet 129A may be disposed at a portion displaced from the portion above the removing member 150.

In the present exemplary embodiment, the removing member 150 is disposed in the inlet passage 129. However, this is not the only possible structure. For example, the removing member 150 may be disposed outside the inlet passage 129.

In the present exemplary embodiment, the attachment portions 156 of the removing member 150 are attached to the housing 110 outside the inlet passage 129. However, this is not the only possible structure. For example, the attachment portions 156 may be attached to the housing 110 inside the inlet passage 129.

In the present exemplary embodiment, the attachment portions 156 are attached to the housing 110 outside the transport path 112. However, this is not the only possible structure. For example, the attachment portions 156 may be attached to the housing 110 inside the transport path 112.

In the present exemplary embodiment, the removing member 150 is formed of a thin wire, as illustrated in FIG. 4. However, this is not the only possible structure. For example, the removing member 150 may be formed of a plate.

In the present exemplary embodiment, the removing member 150 is disposed at a downstream end portion of the transport path 112. However, the removing member 150 may be disposed at an upstream end portion of the transport path 112 or a middle portion in the transport direction. In such a case, the removing member 150 may be disposed in, for example, any of the inlet passages 121, 122, 123, 124, 125, 126, 127, and 128.

In the present exemplary embodiment, the removing member 150 is disposed above the transport member 130. However, the removing member 150 may be disposed horizontally or below the shaft 132 of the transport member 130. Specifically, the removing member 150 may be disposed at any portion in the peripheral direction of the shaft 132 of the transport member 130.

In the present exemplary embodiment, the transport device 100 transports waste toner. However, this is not the only possible structure. For example, the transport device 100 may be a transport device that transports toner for forming an image or other granular materials.

The present invention is not limited to the above-described exemplary embodiments, and may be modified, changed, or improved in various manners within the scope not departing from the gist of the invention. For example, any of the modifications described above may be appropriately combined together.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A transport device comprising:
a transport member that includes a shaft and a blade helically extending on an outer peripheral surface of the shaft, the transport member transporting a granular material with a rotation of the shaft;
a moving member that extends from an outer side of the transport member in a radial direction to the shaft, the moving member including a distal end portion moving in an axial direction of the shaft in a gap defined by the blade;
an outlet, through which the transport member causes the granular material to drop from the transport member, is disposed below the distal end portion of the moving member,
wherein the distal end portion is configured to move in the axial direction and the radial direction of the shaft, the radial direction being parallel with a direction of the granular material dropping from the transport member.

2. The transport device according to claim 1,
wherein the moving member has the distal end portion pressed against a surface of the blade facing downstream in a transport direction,
wherein, when the transport member rotates, the distal end portion is pressed by the blade against a pressing force of the distal end portion on the blade, and the distal end portion moves downstream in the transport direction and outward in the radial direction in the axial direction about a positioning portion of the moving member, the positioning portion being disposed on an outer side of the transport member in the radial direction, and
wherein, after the distal end portion reaches an outer side of the blade in the radial direction, the distal end portion moves upstream in the transport direction in the axial direction in the gap defined by the blade with the pressing force.

3. The transport device according to claim 2, wherein the positioning portion is disposed upstream from the distal end portion in the transport direction.

4. The transport device according to claim 2, wherein a distance from the positioning portion to the distal end portion is longer than a dimension of the gap defined by the blade.

5. The transport device according to claim 2,
wherein the moving member includes a proximal end portion attached to a transport device body,
wherein the positioning portion is a middle portion between the proximal end portion and the distal end portion, and disposed on an outer side, in the radial direction, of a portion at which the proximal end portion is attached.

6. The transport device according to claim 1, wherein the distal end portion of the moving member comes into contact with the outer peripheral surface of the shaft.

7. (canceled)

8. The transport device according to claim 1, wherein an inlet, through which the transport member causes the granular material to flow into a transport area over which the granular material is transported, is disposed above the distal end portion of the moving member.

9. The transport device according to claim 8,
wherein at least part of the moving member from a positioning portion to the distal end portion is disposed in a fall passage through which the granular material that has flowed into the inlet falls freely, the positioning portion being disposed on an outer side of the transport member in the radial direction.

10. The transport device according to claim 8,
wherein the moving member includes a proximal end portion attached to a transport device body outside a fall passage through which the granular material that has flowed into the inlet falls freely.

11. The transport device according to claim 1,
wherein the moving member includes a proximal end portion attached to a transport device body outside a transport area over which the transport member transports the granular material.

12. The transport device according to claim 1,
wherein the moving member is formed from a thin wire.

13. The transport device according to claim 12,
wherein the moving member includes
a first portion extending in a direction tangential to the shaft and forming the distal end portion of the moving member, and
second portions extending outward in the radial direction of the transport member from a first end and a second end of the first portion.

14. The transport device according to claim 1,
wherein the distal end portion of the moving member is pressed against a surface of the blade facing downstream in a transport direction so as to be movable downstream in the transport direction and outward in the radial direction in the axial direction about a positioning portion of the moving member, the positioning portion being disposed on an outer side of the transport member in the radial direction.

15. An image forming apparatus, comprising:
an image forming unit that forms a toner image on a recording medium;
the transport device according to claim 1 that transports toner, which is a granular material discharged from the image forming unit; and
a container unit that contains the toner transported by the transport device.

16. The image forming apparatus according to claim 15,
wherein the image forming unit includes
a plurality of carriers that hold toner images,
an intermediate transfer body, to which the toner images are transferred from the plurality of carriers and which transfers the toner images to a recording medium,
a first removing unit that removes toner from the carriers, and
a second removing unit that removes toner from the intermediate transfer body,
wherein an inlet, through which the transport member causes the granular material to flow into a transport area over which the granular material is transported, is disposed above the distal end portion of the moving member,
wherein the toner removed by the second removing unit flows in from the inlet, and
wherein the toner removed by the first removing unit flows to the transport area at a portion upstream from the inlet in a transport direction.
